(19) United States
(12) Patent Application Publication
(10) Pub. No.: US 2021/0260564 A1
(43) Pub. Date: Aug. 26, 2021

(54) METHOD FOR MICROEXTRUSION OF SHAPED BODIES THROUGH A PLURALITY OF MICROEXTRUSION NOZZLES

(71) Applicants: BASF SE, Ludwigshafen am Rhein (DE); VITO NV, Mol (BE)

(72) Inventors: Marco Oskar KENNEMA, Ludwigshafen am Rhein (DE); Christian WALSDORFF, Ludwigshafen am Rhein (DE); Bart MICHIELSEN, Mol (BE); Jasper LEFEVERE, Mol (BE)

(21) Appl. No.: 17/270,978

(22) PCT Filed: Aug. 7, 2019
(86) PCT No.: PCT/EP2019/071222

§ 371 Date: Feb. 24, 2021

(30) Foreign Application Priority Data
Aug. 24, 2018 (EP) 18190701.5

(51) Int. Cl. B01J 20/30; B01J 37/00; B01J 37/08; B29C 64/118; B29C 64/171; B29C 64/209; B29C 64/227; B33Y 10/00

(52) U.S. Cl. CPC B01J 20/3007; B01J 20/3078; B01J 37/0009; B01J 37/08; B33Y 10/00; B29C 64/171; B29C 64/209; B29C 64/227; B29C 64/118

(57) ABSTRACT

Process for producing shaped bodies of catalysts, catalyst supports or adsorbents by microextrusion in which a pasty extrusion composition of a shaped body precursor material is extruded through a movable microextrusion nozzle and through movement of the microextrusion nozzle a shaped body precursor is constructed in layerwise fashion and the shaped body precursor is subsequently subjected to a thermal treatment, wherein for construction of each shaped body precursor the pasty extrusion composition is simultaneously extruded through a plurality of microextrusion nozzles.

The invention relates to a process for producing catalyst and catalyst support or adsorbent shaped bodies by microextrusion, wherein a shaped body is constructed by a plurality of microextrusion nozzles. Processes for additive manufacturing of chemical catalysts by microextrusion are also referred to as “robocasting” or “direct-ink-writing” (DIM).

Many processes employ chemical catalysts in the form of shaped bodies. Such shaped bodies are often in the form of cylinders, hollow cylinders or spheres. Shaped bodies having for example tri-lobal or star-shaped cross sections or having a plurality of hollow cylindrical openings are also used. Such shaped bodies are produced by extrusion, tabletting or in the case of spheres also by agglomeration on rotating plates.

However, the topological degrees of freedom of shaped bodies that may be produced with such classical methods are generally limited.

EP 1127618 A1 describes hollow cylinders produced by tabletization having rounded end faces. DE 102 26 729 A1 describes cylinders produced by extrusion having notches parallel to the extrusion direction. WO 2016/156042 A1 describes shaped bodies produced by extrusion having four parallel hollow cylindrical openings.

A greater diversity of shaped body topologies is producible by additive manufacturing processes, often also referred to as 3D printing processes.

The umbrella term additive manufacturing processes subsumes a series of different processes. These have in common that a three-dimensional shaped body is constructed by additive means, i.e. by successive addition of material.

For the production of chemical catalysts two types of additive manufacturing processes in particular have been described.

U.S. Pat. No. 8,119,554 describes a so-called powder bed printing process for producing chemical catalysts. U.S. Pat. No. 9,278,338 likewise describes a so-called powder bed printing process for producing chemical catalysts. Both documents also describe catalyst shaped bodies having geometries which would not be obtainable by classical tabletization or extrusion processes. WO 2016/166526 and WO 2016/166523 also describe the production of catalyst shaped bodies having geometries that would not be attainable by classical tabletization or extrusion processes.

However, powder printing processes are of only limited suitability for producing chemical catalysts. Difficulties arise for example when constituents of the powder react with the liquid adhesive or are soluble therein. The thus obtained shaped bodies must generally also be calcined at high temperatures to achieve a sufficient mechanical stability and this may have a strong influence on the catalytic properties. The specific density and thus also the active composition available in a volume element are often low.

C. R. Tubío et al. describe in Journal of Catalysis 334 (2016) 110 to 115 the production of a chemical catalyst shaped body by means of a robocasting process. The thus obtained catalyst shaped bodies having a structure described by the authors as “wood pile” would not be obtainable with classical extrusion and tabletization processes either. One advantage of such robocasting methods is that the starting materials are treated in a manner similar to classical extrusion processes which imbues the methods with a relatively broad applicability.

3D-microextrusion technology (3D-robocasting technology) is described for example in U.S. Pat. Nos. 7,527,671, 6,027,326, 6,401,795, Catalysis Today 273 (2016), pages 234 to 243, Journal of Catalysis 334 (2016), pages 110 to 115 or U.S. Pat. No. 6,993,406.

Catalyst shaped bodies may be employed individually or in small numbers, for example in the form of monoliths such as in automotive exhaust gas catalysts. In processes for producing chemicals catalyst shaped bodies are often not employed individually but rather in the form of dumped packings, so-called catalyst beds.

Shaped bodies having geometries attainable by additive manufacturing techniques may have various advantages over classical geometries accessible by tableting or extrusion for chemical catalysts. Shaped bodies having macroscopic channel structures may in particular have a relatively high geometric surface area per catalyst bed volume at relatively low pressure drop.

Additive manufacturing processes are often also described as “rapid prototyping”. They were thus often developed to be able to produce prototypes of particular shaped bodies typically as a one-off or in small batches. However, chemical catalyst shaped bodies for use in commercial reactors are often required on a scale of several tons up to several hundred tons for filling a single reactor line. This corresponds to millions of shaped bodies.

In prior art processes for microextrusion of catalysts and catalyst supports the shaped bodies of the catalyst or catalyst support are in each case produced by extrusion of a corresponding composition from an extrusion head, wherein generally the extrusion head is moved in three spatial directions and has a single opening for extrusion of only a single strand in each case.

Such a prior art extrusion head having only a single opening for extrusion does allow construction of very individually dimensioned shaped bodies (rapid prototyping) but is rather unsuitable for mass production of a multiplicity of identical shaped bodies. The construction of each individual layer of a shaped body of a catalyst or catalyst support produced by microextrusion according to the prior art generally requires many very accurate and preferably rapid and sudden changes in the direction of motion of the extrusion head. This is particularly problematic in mass production of catalysts or catalyst supports since this is generally concerned not with the possibility of individually dimensioning single shaped bodies but rather largely error-free production of standardized shaped bodies in large numbers with high reliability.

The present invention accordingly has for its object to find a process which allows cost-effective production of catalysts or catalyst supports as shaped bodies in large numbers.

The object is achieved by a process for producing shaped bodies of catalysts, catalyst supports or adsorbents by microextrusion in which a pasty extrusion composition of a shaped body precursor material is extruded through a movable microextrusion nozzle and through movement of the microextrusion nozzle a shaped body precursor is constructed in layerwise fashion and the shaped body precursor is subsequently subjected to a thermal treatment, wherein for construction of each shaped body precursor the pasty extrusion composition is simultaneously extruded through a plurality of microextrusion nozzles.

The thus produced shaped bodies may comprise only the support material, the support material and one or more active components or only active components, depending on the type of the employed extrudable formulation. It is preferable when by microextrusion and joining of discontinuous strands macroscopically porous catalyst shaped bodies, catalyst support shaped bodies or adsorbent shaped bodies are produced.

Generally a plurality of microextrusion nozzles fed conjointly by a stream of extrusion composition are arranged next to one another in a row in an extrusion head and are moved conjointly with said head. The above-described disadvantages are thus remedied by the process according to the invention in that an extrusion head has a plurality of openings for microextrusion of strands for the construction of microextruded shaped bodies.

The invention is more particularly elucidated by the FIGS. 1 to 4.

FIG. 1 shows a schematic diagram of an extrusion head having a plurality of microextrusion nozzles and parallel strands of extrusion composition simultaneously extruded therethrough.

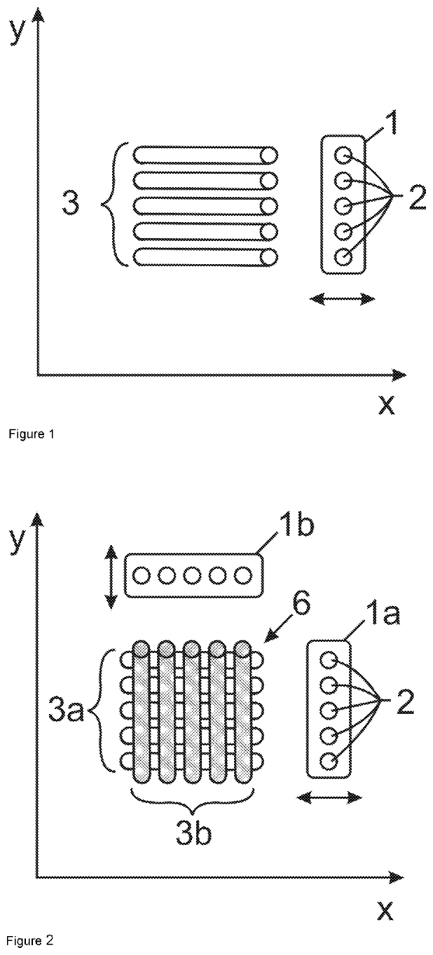

FIG. 2 shows a schematic diagram of an arrangement of two extrusion heads which each have a plurality of microextrusion nozzles and are arranged and moved perpendicularly to one another and the thus extruded layers of strands of extrusion composition.

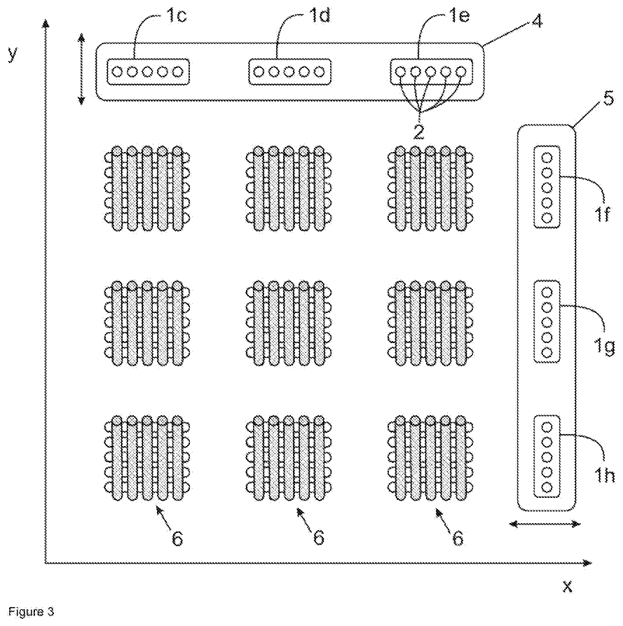

FIG. 3 shows a schematic diagram of an arrangement of units of a plurality of securely mechanically interconnected extrusion heads, wherein the units are arranged and moved perpendicularly to one another, and the thus generated plurality of shaped body precursors composed of layers of extruded strands present in the construction.

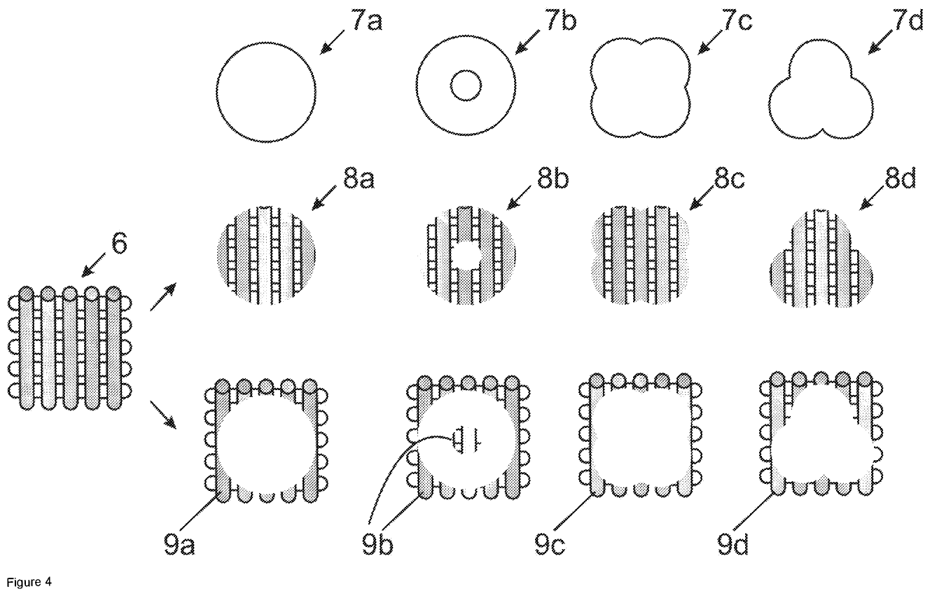

FIG. 4 shows a schematic diagram of the stamping-out of cylindrical, ring-shaped or multilobal structures from a cuboidal “wood pile” structure generated by microextrusion.

The openings (microextrusion nozzles) of an extrusion head are preferably arranged in a row such that moving the extrusion head perpendicularly to the alignment of this row causes the microextruded strands to be formed in a parallel arrangement, preferably such that they do not touch one another. A schematic diagram of such an extrusion head is shown in FIG. 1. A plurality of microextrusion nozzles 2 arranged in one extrusion head 1 simultaneously generate a layer 3 of a plurality of parallel strands.

In a preferred embodiment of the process according to the invention at least two extrusion heads are involved in the construction of the individual shaped bodies. Such a process is illustrated by way of example in FIG. 2. At least two extrusion heads 1a and 1b are arranged such that during the extrusion process they are moved in stepwise fashion vertically and horizontally, i.e. in the plane of the layerwise construction of the shaped body precursors, in each case only either in the x-direction or in the y-direction. To this end in the successive layerwise construction of a shaped body from layers 3a and 3b of microextruded strands said heads are alternately passed over a shaped body present in the construction. It is in particular also possible to construct a multiplicity of shaped body precursors simultaneously, wherein the two extrusion heads 1a and 1b are alternately each passed over a multiplicity of shaped body precursors present in the construction.

In this embodiment of the process according to the invention the layerwise construction of shaped body precursors is carried out by at least two extrusion heads moved in spatial directions perpendicular to one another.

In a preferred embodiment extrusion heads moving in the x- or y-direction each construct a plurality of shaped body precursors in layerwise fashion.

It is also possible in the process according to the invention to securely mechanically combine a plurality of extrusion heads such that they can each be moved synchronously in the x- or y-direction. A schematic diagram of this is shown in FIG. 3. Extrusion heads 1a, 1b and 1c are securely mechanically connected to afford a unit 4 movable in the y-direction and extrusion heads 1d, 1e and 1f are securely mechanically connected to afford a unit 5 movable in the x-direction.

In this embodiment of the process according to the invention a plurality of extrusion heads are mechanically coupled and are moved conjointly.

In a further embodiment of the process according to the invention the extrusion heads according to the invention having a plurality of microextrusion nozzles may also be rotatable. They may be rotatable for example by a particular angle, for example by 90°, and after extrusion of any layer of parallel microextruded strands during construction of a shaped body be rotated by this angle, for example 90°, in a plane parallel to the plane in which the strands are microextruded.

In a preferred embodiment of the process according to the invention for layerwise construction of shaped body precursors the extrusion head is rotated horizontally by 90° and moved in spatial directions perpendicular to one another.

A plurality of extrusion heads that are securely mechanically interconnected may also be aligned rotated by an angle, for example by 90°, by rotating the whole unit of securely connected extrusion heads. In this embodiment of the process according to the invention a plurality of extrusion heads are thus likewise securely mechanically coupled and are moved conjointly.

The process according to the invention allows shaped bodies having different geometries of outer contour to be formed. A geometry advantageous in respect of porosity and mass transfer properties is exhibited for example by so-called “wood pile-like” structures having a cuboidal contour. However, catalysts or catalyst supports having a cuboidal contour geometry are not always advantageous for use in dumped beds of such catalyst shaped bodies in terms of their packing properties. It may be advantageous here, as shown schematically in FIG. 4, to use stamping dies 7a, 7b, 7c or 7d to stamp out cylindrical structures 8a, ring-shaped structures 8b or multilobal structures 8c or 8d from cuboidal “wood pile” structures 6. The resulting scraps 9a, 9b, 9c or 9d are advantageously recycled into the production process optionally after a milling step.

The microextrusion nozzles generally have a diameter of less than 5 mm, preferably of less than 4 mm, particularly preferably of 0.05 to 3 mm, in particular of 0.2 to 2 mm.

The geometric resolution of shaped bodies produced by the process according to the invention is naturally defined by the diameter of the microextrusion nozzles. The process according to the invention is preferably used to produce shaped bodies having a minimum diameter of at least 3 mm, particularly preferably of at least 5 mm and in particular of at least 10 mm.

The maximum size of the shaped bodies produced according to the invention is substantially defined by the dimensions of the platform according to the invention and any enclosures and also the movement range of the microextrusion heads. The maximum diameter of the catalysts produced according to the invention is preferably not more than 1 m, particularly preferably not more than 30 cm and in particular not more than 10 cm.

Dimensions greater than 10 cm are contemplated in particular for monolithic shaped bodies which are generally fitted very precisely into an apparatus for performing catalytic reactions. Examples of such applications include many processes for exhaust gas treatment.

Dimensions of not more than 10 cm, preferably of not more than 5 cm and in particular of not more than 3 cm are contemplated in particular for shaped bodies which are not individually fitted into an apparatus for performing catalytic reactions but rather are used as a so-called dumped packing in a catalyst bed. Examples of such apparatuses are adiabatic or isothermal reactors or any desired intermediate forms, in particular in the form of tube-bundle, plate, dumped packing or tray reactors. Examples of such processes include many chemical industry processes for producing chemical compounds.

Drying or further thermal treatment can also bring about a shrinking of the catalyst shaped bodies produced according to the invention which may need to be taken into account in the dimensioning of the microextrusion nozzles and the freshly microextruded (“green”) shaped bodies.

Formulations also used in standard extrusion processes are in principle suitable as extrusion compositions. It is a prerequisite that the particle size of the catalyst precursor material is sufficiently small for the microextrusion nozzle. The largest particles (d99 value) should preferably be at least five times smaller, in particular at least ten times smaller, than the nozzle diameter.

Suitable formulations are pasty suspensions exhibiting the rheological properties required for microextrusion. The abovementioned literature describes in detail how suitable rheological properties may be established. If necessary, binders and viscosity-modifying additions such as starch or carboxymethylcellulose may be added to the formulations.

The microextrudable pasty suspension preferably contains water as liquid diluent but organic solvents may also be employed. The suspension may contain not only catalytically active compositions or precursor compounds for catalytically active compositions but also an inorganic support material or inert material. Examples of commonly used support or inert materials are silicon dioxide, aluminum oxide, diatomaceous earth, titanium dioxide, zirconium dioxide, magnesium oxide, calcium oxide, hydrotalcites, spinels, perovskites, metal phosphates, metal silicates, zeolites, steatites, cordierites, carbides and mixtures thereof.

The process according to the invention may also be used to produce shaped bodies essentially comprising only a support material or an inert material. Such shaped bodies produced by the process according to the invention may then be converted into catalyst shaped bodies in further process steps, for example by impregnation or coating and optionally further thermal treatment steps.

The geometric resolution of shaped bodies produced by the process according to the invention is naturally defined by the diameter of the microextrusion nozzles. The process according to the invention is preferably used to produce shaped bodies having a minimum diameter of at least 3 mm, particularly preferably of at least 5 mm and in particular of at least 10 mm.

Examples for the use of the process according to the invention may be monolithic shaped bodies for treatment of exhaust gases, for example nitrogen oxides or laughing gas.

Examples for the use of the process according to the invention also include shaped bodies typically employed as a dumped packing in a catalyst bed, for example in processes for producing synthesis gas, for oxidation of sulfur dioxide to sulfur trioxide or for oxidation of ethylene to ethylene oxide.

Suitable extrudable formulations for producing catalysts for oxidation of SO₂ to SO₃ are described for example in WO 2016/156042 A1, see in particular example 1 of WO 2016/156042 A1. In one embodiment the inventive process for producing catalyst shaped bodies is used for the oxidation of SO₂ to SO₃.

The shaped body precursors are preferably constructed on a movable base (platform). The platform may be moved continuously or discontinuously relative to the microextrusion nozzles and extrusion heads.

In one embodiment of the invention the platform is moved discontinuously after layerwise generation of a plurality of shaped body precursors. For example after robocasting of a plurality of shaped bodies the platform may be moved sufficiently far forward that for the next robocasting step a free region of the platform is available again.

However, in a preferred embodiment of the invention the platform is moved continuously during the layerwise generation of the shaped bodies, wherein the movement of the micronozzles compensates for the movement of the platform. To this end the electronic control means of the microextrusion nozzles/the extrusion heads in the three spatial directions is configured such that the translation movement of the platform is compensated by an additional translation movement of the microextrusion nozzles/the extrusion heads. Such a control compensation by vectorial movement components which compensate the movement of the platform is known to those skilled in the art.

The geometric resolution (accuracy) of the shaped bodies produced with the process according to the invention is also defined by the accuracy of the movement and positioning of the microextrusion nozzles/extrusion heads and the platform, in particular also by the accuracy of the relative movement between the microextrusion nozzles/extrusion heads and the platform. An estimate of the accuracy of the movement and positioning of the microextrusion nozzles/extrusion heads and the platform necessary for a desired resolution of the shaped bodies according to the invention is possible for those skilled in the art according to the prior art using general mathematical knowledge.

It is preferable when the platform moves continuously or discontinuously from a region in which the robocasting steps are performed to a region in which a thermal treatment is performed. In a preferred embodiment the movable platform is a circulating belt. The circulating belt may be a continuous belt, for example a hard rubber belt. It is preferable to employ a chain belt or a plate belt made of a metallic material of construction. Ceramic materials of construction for example may also be employed as the platform and the segments of a belt structure. Plastics too, for example Teflon, may be employed provided this is permitted by the temperatures of the thermal treatment. This belt structure is preferably arranged like the track of a tracked vehicle so that segments of the belt structure return to their starting point after one circulation.

In a preferred embodiment on the circulating belt the shaped bodies are subjected to a drying as the thermal treatment, wherein the belt traverses at least one drying zone. The drying may be effected in a plurality of drying zones at different temperatures. It is preferable when the circulating belt exhibits perforations and a drying by means of a heated gas which flows through the perforations in the at least one drying zone is effected. However, generation of the catalyst shaped body precursors by microextrusion and thermal treatment of same may also be effected on different circulating belts.

Thus, after traversing a first region in which the robocasting steps are performed and at least a second region in which a thermal treatment is performed the belt is deflected such that the shaped bodies fall off and for example are passed into a further process step while the belt is guided back in the opposite direction and after a renewed deflection is passed back into the region in which the robocasting steps are performed.

After leaving the belt structure the shaped bodies may be subjected to one or more further process steps, for example a further thermal treatment, in particular at higher temperatures, or a finishing or packaging step.

The deflection of the belt structure according to the invention may be effected for example via rollers, wheels or cogwheels.

The platform and belt structure is preferably perforated, i.e. provided with openings so that a gas stream may be guided vertically through the belt structure, in particular in order to ensure a uniform thermal treatment or drying of the shaped bodies.

The platform and belt structure may be in the form of a net or braid or in the form of plates connected with hinges. It is preferable when the belt, or the individual segments of the belt, is/are made of a metallic material of construction.

The heat input in the thermal treatment step may be effected for example by means of microwave radiation, electrically or steam powered assemblies, direct heating with a fuel gas or by introduction of a preheated gas.

In the process according to the invention it is preferable when at least individual regions of the platform (belt structure) are arranged in a largely closed or at least aspiratable housing (chamber). Particularly the thermal treatment step is generally performed in a closed system such as in a belt dryer or a belt calciner. The terms belt dryer and belt calciner may overlap and a belt calciner may thus be constructed similarly to a belt dryer but is operated at relatively higher temperatures. Drying steps and further thermal treatment steps (calcining steps) may also be performed in a common apparatus which may then preferably be operated with a series of more or less sharply separated temperature zones.

A suitable belt calcining apparatus is described in EP 1 889 657 A2 for example. Said apparatus comprises as a means for generating the gas circulation a ventilator which is suitably arranged above the conveyor belt in the chamber (the chambers). In suitable embodiments the means for generating the gas circulation also comprise gas guiding devices for guiding the gas circulation inside the chamber, wherein the gas guiding devices extend inside the chamber in each case at the edge of the conveyor belt substantially in a plane perpendicular to the contact surface of the conveyor belt. The means for generating the gas circulation and/or the gas guiding devices are advantageously configured such that the gas ascends through the gas-permeable conveyor belt and the particulate catalyst precursors present thereupon and descends again at the walls of the chamber. Conversely, however, a gas circulation in the opposite direction is also conceivable. If the belt calcining apparatus comprises at least two heatable chambers, said chambers are preferably delimited from one another such that essentially no gas exchange between the chambers takes place. To remove decomposition gases and the like it is preferable when a portion of the gas recirculated in the chamber is continuously or periodically removed and replaced by fresh gas. The supply of fresh gas is controlled such that the temperature consistency in the chamber is not impaired. The volume of the gas circulated in the chamber per unit time is generally greater than the volume of the gas supplied to or discharged from the chamber per unit time and is preferably at least five times the amount thereof.

It is also possible for a plurality, for example two or three, of the above-described belt calcining apparatuses to be traversed successively. The catalyst precursor may optionally be collected and intermediately stored after traversing one apparatus and before traversing a further apparatus.

The region in which the robocasting step is performed may also be surrounded by an aspiratable housing. This is required in particular when the catalyst materials comprise health-hazardous substances or flammable solvents are employed in the production of the extrudable pastes. Also optionally provided in case of use of organic additives or other substances which may form explosive gas atmospheres, for example ammonia, is a configuration of the housing and the offgas aspiration as an explosion control area. Treatment of the waste air aspirated from the housing by means of filters, scrubbers, incineration plants or DeNOx devices may also be required. In case of aspiration of the housing a corresponding feed air supply is preferably also provided.

In one embodiment of the process according to the invention a continuous or discontinuous cleaning of the platform (belt structure) of any deposits also takes place. This may be effected for example mechanically through brushes or using a cleaning liquid, for example by means of spray nozzles. A cleaning is thus preferably performed automatically in a section of the belt structure outside the region of the robocasting or the thermal treatment step.

### LIST OF REFERENCE NUMERALS

1, 1a, 1b, 1c, 1d, 1e, 1f, 1g movable extrusion heads
2 microextrusion nozzles
3, 3a, 3b layers of parallel extruded strands
4, 5 movable units of a plurality of mechanically connected extrusion heads
6 cuboidal “wood pile” structure
7a, 7b, 7c, 7d stamping dies
8a, 8b, 8c, 8d stamped out “wood pile” structures having the target geometry
9a, 9b, 9c, 9d scraps

1.-12. (canceled)

13. A process for producing shaped bodies of catalysts, catalyst supports or adsorbents by microextrusion in which a pasty extrusion composition of a shaped body precursor material is extruded through a movable microextrusion nozzle and through movement of the microextrusion nozzle a shaped body precursor is constructed in layerwise fashion and the shaped body precursor is subsequently subjected to a thermal treatment, wherein for construction of each shaped body precursor the pasty extrusion composition is simultaneously extruded through a plurality of microextrusion nozzles arranged in a row in an extrusion head, wherein for layerwise construction of a shaped body precursor an extrusion head is rotatable horizontally by 90° and moved in spatial directions perpendicular to one another or the layerwise construction of a shaped body precursor is carried out by at least two extrusion heads moved in spatial directions perpendicular to one another.

14. The process according to claim 13, wherein a plurality of extrusion heads are mechanically coupled and are moved conjointly.

15. The process according to claim 13, wherein a plurality of shaped body precursors are simultaneously generated on a movable platform.

16. The process according to claim 15, wherein the platform is moved continuously relative to the microextrusion nozzles.

17. The process according to claim 15, wherein the platform is moved discontinuously relative to the microextrusion nozzles.

18. The process according to claim 17, wherein the platform is moved discontinuously after generation of a plurality of shaped body precursors.

19. The process according to claim 15, wherein during generation of the shaped body precursors the platform is moved continuously, wherein the movement of the microextrusion nozzles compensates the movement of the platform.

20. The process according to claim 16, wherein the movable platform is a circulating belt.

21. The process according to claim 20, wherein the circulating belt is a continuous belt.

22. The process according to claim 20, wherein the circulating belt comprises individual segments.

23. The process according to claim 20, wherein on the circulating belt the shaped body precursors are subjected to a drying as the thermal treatment, wherein the belt traverses at least one drying zone.

24. The process according to claim 23, wherein the circulating belt is part of a belt dryer or belt calciner.

25. The process according to claim 23, wherein the circulating belt comprises perforations and a drying by means of a heated gas which flows through the perforations in the at least one drying zone is effected.

26. A process for producing shaped bodies of catalysts, catalyst supports or adsorbents comprising:
microextruding a pasty extrusion composition of a shaped body precursor material through a movable microextrusion nozzle;
constructing a shaped body precursor in layerwise fashion through movement of the microextrusion nozzle; and
subsequently subjecting the shaped body precursor to a thermal treatment, wherein for construction of each shaped body precursor the pasty extrusion composition is simultaneously extruded through a plurality of microextrusion nozzles arranged in a row in an extrusion head, wherein for layerwise construction of a shaped body precursor an extrusion head is rotatable horizontally by 90° and moved in spatial directions perpendicular to one another or the layerwise construction of a shaped body precursor is carried out by at least two extrusion heads moved in spatial directions perpendicular to one another.
